(19) United States
(12) Patent Application Publication
(10) Pub. No.: US 2010/0055657 A1
(43) Pub. Date: Mar. 4, 2010

(54) RADIOGRAPHIC AND ULTRASOUND SIMULATORS

(76) Inventors: Warren Goble, Tucson, AZ (US); Michael Valdiserri, Tucson, AZ (US)

Correspondence Address: GREENBERG TRAURIG (PHX), INTELLECTUAL PROPERTY DEPARTMENT, 2450 COLORADO AVENUE , SUITE 400E, SANTA MONICA, CA, 90404, US

(21) Appl. No.: 12/549,353

(22) Filed: Aug. 27, 2009

Related U.S. Application Data
(60) Provisional application No. 61/092,350, filed on Aug. 27, 2008.
(60) Provisional application No. 61/092,353, filed on Aug. 27, 2008.
(60) Provisional application No. 61/093,135, filed on Aug. 29, 2008.
(60) Provisional application No. 61/093,152, filed on Aug. 29, 2008.

(51) Int. Cl. G09B 19/00; G09B 23/28

(52) U.S. Cl. 434/262; 434/219

(57) ABSTRACT

Some embodiments of the invention provide methods of simulating an X-ray machine or an ultrasound machine on a computer to train users. The methods comprise providing a server, in communication with the computer, including a database and a processor and also providing at least one simulator viewing window including a virtual body and a virtual X-ray tube or a virtual ultrasound probe and at least one simulated image viewing window including a simulated radiographic image or a simulated ultrasound image. The method further comprises the processor using the position of the virtual body and the virtual X-ray tube or the virtual ultrasound probe, controlled by the user, to generate the simulated radiographic image or the simulated ultrasound image.

### RELATED APPLICATIONS

This application claims priority under 35 U.S.C. §119 to U.S. Provisional Patent Application Nos. 61/092,350 filed on Aug. 27, 2008, 61/092,353 filed on Aug. 27, 2008, 61/093,135 filed on Aug. 29, 2008, and 61/093,152 filed on Aug. 29, 2008, the entire contents of which are incorporated herein by reference.

### BACKGROUND

Basic X-ray technologist and technician programs require participation in theoretical as well as hands-on training. While theoretical training can include classes in anatomy, patient care, radiography, etc., hands-on training can include practice taking X-ray images with an X-ray machine. There are many variables that can affect an X-ray image, and many times, students can only learn how to avoid taking useless or ineffective X-ray images through practice and real use with an X-ray machine. However, because excess radiation is harmful to people, it is difficult for students to continuously train on human subjects.

Hands-on training for ultrasound can be equally as difficult. While students can practice using an ultrasound machine on a patient, each student will get a different experience. To have a class full of students each practice on the same patient would be time consuming as well as not comfortable for the patient. In addition, some students may not have the chance to practice with different patients, such as pregnant females, infants or patients with certain diseases.

### SUMMARY

Some embodiments of the invention provide a method of simulating an X-ray machine on a computer to train a user to operate the X-ray machine. The method comprises providing a server including a database and a processor, where the computer is in communication with the server, and the computer including a user interface and at least one of a mouse and a keyboard. The method also comprises providing at least one simulator viewing window including a virtual body and a virtual X-ray tube and at least one simulated image viewing window including a simulated radiographic image on the user interface, and the user controlling a position of the virtual body and the virtual X-ray tube in the simulator viewing window using at least one of the mouse and the keyboard. The method further comprises the processor using the position of the virtual body and the virtual X-ray tube to generate the simulated radiographic image.

Some embodiments of the invention provide a method of simulating an ultrasound machine on a computer to train a user to operate the ultrasound machine. The method comprises providing a server including a database and a processor, where the computer is in communication with the server, and the computer including a user interface and at least one of a mouse and a keyboard. The method also comprises providing at least one simulator viewing window including a virtual body and a virtual ultrasound probe and at least one simulated image viewing window including a simulated ultrasound image on the user interface, and the user controlling a position of the virtual body and the virtual ultrasound probe in the simulator viewing window using at least one of the mouse and the keyboard. The method further comprises the processor using the position of the virtual body and the virtual ultrasound probe to generate the simulated ultrasound image using an authentic ultrasound image stored in the database.

### DESCRIPTION OF THE DRAWINGS

FIG. 1 is a block diagram of a radiographic simulator according to one embodiment of the invention.

FIG. 2 is a screenshot of a user interface used with the radiographic simulator of FIG. 1.

FIG. 3 is a field of view projection from an X-ray tube as used with the radiographic simulator of FIG. 1.

FIG. 4 is a block diagram of an ultrasound simulator according to another embodiment of the invention.

FIG. 5 is a screenshot of a user interface used with the ultrasound simulator of FIG. 4.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

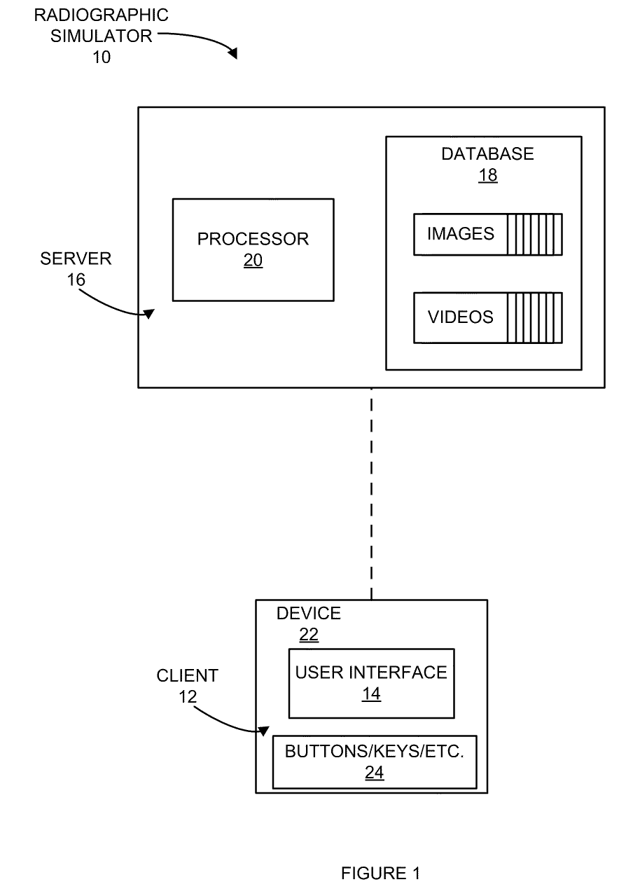

FIG. 1 illustrates a radiographic simulator 10 according to one embodiment of the invention. The radiographic simulator 10 can allow a user to virtually learn how to operate an X-ray machine. The radiographic simulator 10 can function as a client-sever application, where, for example, a client 12 includes a user interface 14 allowing real-time interactivity with the user, and a server 16 functions as a data storing mechanism and a data generator for virtual X-ray images. In some embodiments, the server 16 can include a database 18 for storing images, videos, etc., and a processor 20 for generating data.

In some embodiments, the user interface 14 can run within a web browser (e.g., Windows Internet Explorer®, Mozilla Firefox®, Safari) on a device 22. Training through the user interface 14 can be done from any network compatible device 22 with a display such as a computer, mobile phone, personal digital assistant (PDA), etc. Buttons 24 or similar (e.g., mouse, keypad, touchscreen, etc.) on the device 22 can be used to manipulate various controls on the user interface 14. Through the user interface 14, X-ray images can be generated and viewed to simulate use of a real X-ray hardware machine. Thus, the radiographic simulator 10 can be an effective training tool for users without requiring special equipment such as phantom models and users can train from any location as long as their device 22 can be connected to the server 16.

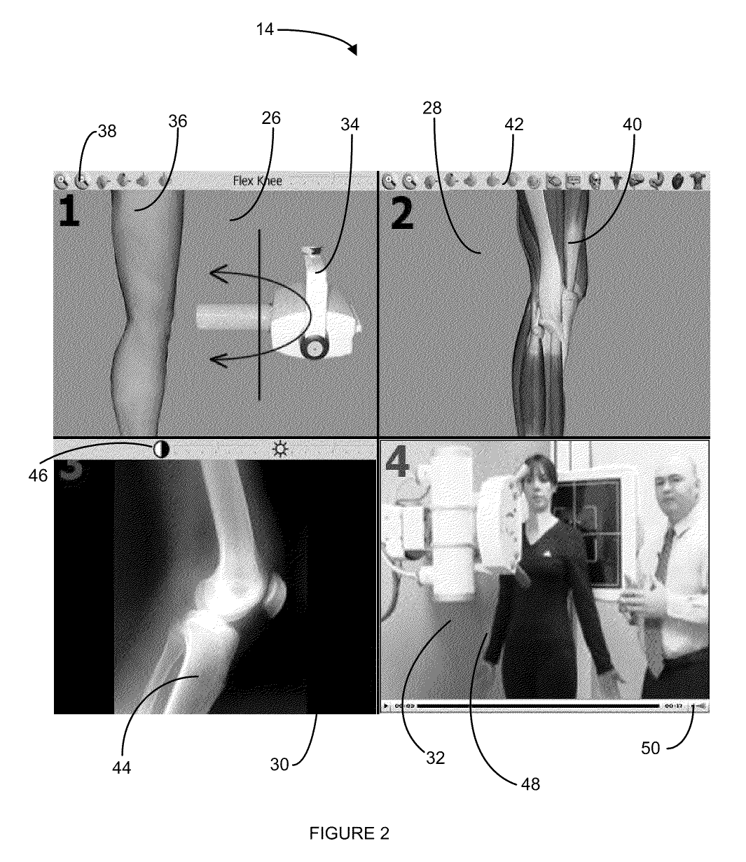

As shown in FIG. 2, the user interface 14 can be broken up into four viewing windows: an X-ray tube simulator window 26, an anatomical reference window 28, an X-ray radiographic window 30, and a video window 32. The four windows can each have different features and functionalities, as described below.

The X-ray tube simulator window 26 can allow the user to virtually position an X-ray tube 34 in relation to a three-dimensional (3-D) model 36 (e.g., of a body) in 3-D space. The model 36 can be loaded into the X-ray tube simulator window 26 via the server 16. The server 16 can be in communication with the client 12 and user interface 14 via the internet or intranet using standard protocols such as HTTP.

In one embodiment, the radiographic simulator 10 can act as a classroom tool, where multiple users are connected to the same server 16 through multiple clients 12 for training. Users can be connected to the server 16 in a classroom or outside the classroom via the internet or intranet. A classroom can be any location for teaching purposes including hospitals, clinics, etc. In addition, specific user progress and user history can be recorded and stored on the server 16 for grading purposes or statistical purposes. Also, one of the clients 12 can act as a broadcast module for collaborative purposes such that the display on the user interface 14 of the broadcast module can be broadcasted to all other clients 12.

In some embodiments, the model 36 can represent a 3-D object using a collection of points in 3-D space, connected by various geometric entities such as triangles, lines, curved surfaces, etc. The user can also choose the model 36 to be X-rayed from a plurality of models, including male or female bodies in small, medium, and/or large body types. Each model 36 can include specific mechanical constraints, such as different ranges of flexibility among different body types.

In the X-ray tube simulator window 26, the user can use controls 38 in the user interface to navigate the X-ray tube 34 around the model 36 in a virtual setting. The user can move the X-ray tube 34 around the model 36 as well as pull it closer or push it farther from the model 36 using the controls 38, such as an X-ray tube kinematics control. The X-ray tube kinematics control can allow the X-ray tube 34 to be manipulated within mechanical constraints similar to a real X-ray tube installed in an imaging center or hospital. For example, a real X-ray tube may need to be positioned relative to an arm or leg of a human body at a specific angle to acquire the correct image. In some embodiments, the controls 38 can include preset kinematics functions with accompanying slider functions, allowing preset procedures for ease of use. These preset kinematics functions can be based on known procedures and may be desirable for novice or beginner users.

In addition, the controls 38 can include a model kinematic function allowing the user to interact with the model 36. For example, the user can virtually flex or extend a knee or rotate a body in the X-ray tube simulator window 26 using the controls 38. This can allow the user to practice positioning a patient, as well as the X-ray tube, for an X-ray. The user can also use the controls 38 to adjust their point of view in the X-ray tube simulator window 26 or to zoom in or out.

The anatomical window reference window 28 can allow an internal view of an anatomical structure 40 for the user that can be navigated in three-dimensional space. The anatomical structure 40 can be shown in three-dimensional virtual space and can be labeled accordingly. In addition, the user can use controls 42 in the anatomical window reference window 28 to toggle views across different internal systems of the anatomical structure 40, such as making skin, bone, and/or muscles invisible or visible.

The anatomical reference window 28 can also function as a 3-D interfacing that leverages model data that is stored on the server 16 (i.e., for the model 36 in the X-ray tube simulator window 26). Specifically, the X-ray tube orientation can be mapped to the internal anatomical structure 40 or, in other words, the model kinematic data can be synced between the anatomical reference window 28 and the X-ray tube simulator window 26. The model data can be rigged with internal moving parts such as muscles and bones, where connected objects can function relative to each other. For example, if a bone in the arm is manipulated, the muscles move with the bone. And thus, when the model 36 is rotated or manipulated in the X-ray tube simulator window 26, the anatomical structure 40 in the anatomical reference window 28 is updated to the same position.

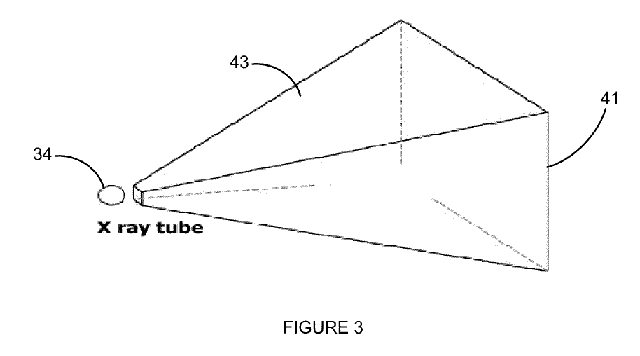

In some embodiments, the anatomical structure 40 shown in the anatomical reference window 28 is within the field of view 41 of the X-ray tube 34, based on the position and orientation of the X-ray tube 34 in the X-ray tube simulator window 26. For example, the X-ray tube simulator window 26 can show the model 36 with skin (as would be seen when positioning an X-ray tube in real life), while the anatomical view window 28 can show the anatomical structure 40 with internal structures based off of the skinned model 36 in the X-ray tube simulator window 26. The anatomical structure 40 can then represent an internal structure of the area where an X-ray would be acquired. As shown in FIG. 3, the determination of the field of view 41 of the X-ray tube 34 can be represented as a pyramid shaped projection 43 and can therefore be based not only where the X-ray tube 34 is positioned laterally, but also how far away the X-ray tube 34 is positioned from the model 36.

The X-ray radiographic window 30 can display a radiographic image 44 based upon the position and orientation of the X-ray tube 34 in the X-ray tube simulator window 26. The X-ray radiographic window 30 can include controls 46 for contrast, brightness, density and peak kilovoltage (kVp) settings, among others, which the user can manipulate. When the X-ray tube 34 is moved in the X-ray tube simulator window 26, both the anatomical structure 40 in the anatomical reference window 28 and the radiographic image 44 in the X-ray radiographic window 30 can be updated based upon the orientation of the X-ray tube 34. Similarly, when the model 36 is manipulated in the X-ray tube simulator window 26, both the anatomical structure 40 in the anatomical reference window 28 and the radiographic image 44 in the X-ray radiographic window 30 can be updated.

The radiographic image 44 shown in the X-ray radiographic window 30 can be computer generated. The user interface 14 can request the appropriate radiographic image 44 from the server 16 based on data such as controls 46 set by the user, the position of the X-ray tube 34, and an orientation of model 36. When the server 16 receives the data from the client 12, it can then render a final radiographic image 44 and send it back to the client 12 to be displayed in the X-ray radiographic window 30. The generated radiographic image 44 can still show muscles and soft tissue as a ghosted overlay giving the appearance of a actual X-ray image. Moreover, radiographic images 44 with material other than bone, such as orthopedic hardware (screws, plates, etc), can also be simulated.

Thus, the user can not only practice positioning the X-ray tube 34, but also view the quality of a radiographic image 44 that would be generated given their positioning and settings. Therefore, the radiographic simulator 10 can allow the user to practice correctly acquiring X-ray images without using an actual X-ray machine or subjecting a human to unnecessary radiation.

The video window 32 can show videos 48 of the actual procedures used to operate an X-ray machine. The video window 32 can be used as a training tool and can be incorporated into an actual training sequence. For instance, videos 48 can be displayed in a sequence depending on a performance of the procedure. Therefore, if a mistake was made by the user, a video 48 can play explaining the error the user made. Videos 48 can be stored in the database 18 on the server 16 and are requested from the client 12. In addition, video controls 50 can be used to play, pause, stop, rewind, fast forward, or volume control the video 48.

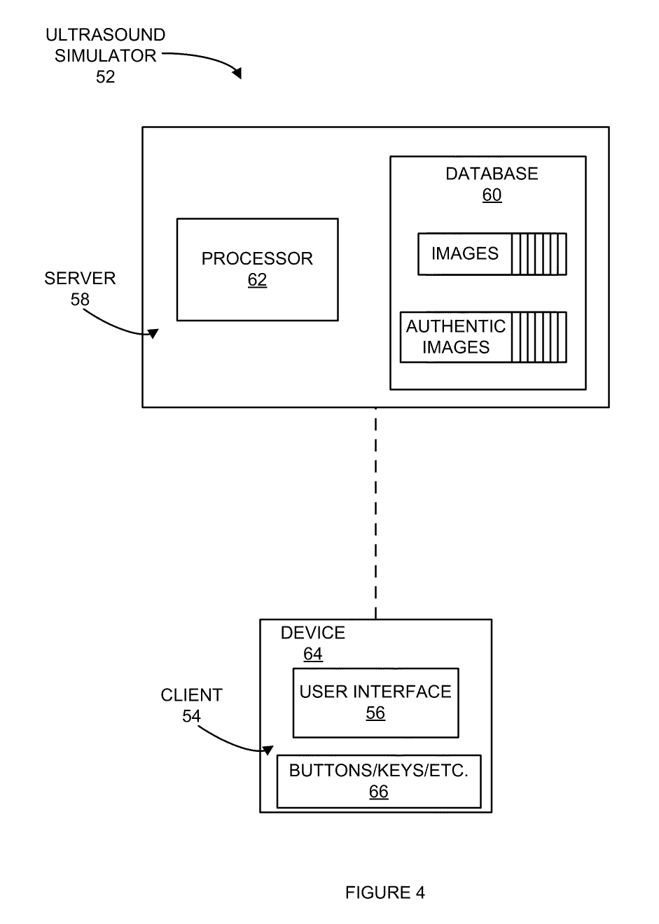

FIG. 4 illustrates an ultrasound simulator 52 according to another embodiment of the invention. The ultrasound simulator 52 can allow a user to virtually learn how to operate an ultrasound machine. The ultrasound simulator 52 can function as a client-server application, where, for example, a client 54 includes a user interface 56 allowing real-time interactivity with the user, and a server 58 functions as a data storing mechanism and a data generator for virtual ultrasound images. In some embodiments, the server 58 can include a database 60 for storing images, videos, etc., and a processor 62 for generating data.

In some embodiments, the user interface 56 can run within a web browser (e.g., Windows Internet Explorer®, Mozilla Firefox®, Safari) on a device 64. Training through the user interface 56 can be done from any network compatible device 64 with a display such as a computer, mobile phone, personal digital assistant (PDA), etc. Buttons 66 or similar (e.g., mouse, keypad, touchscreen, etc.) on the device 64 can be used to manipulate various controls on the user interface 56. Through the user interface 56, ultrasound images can be generated and viewed to simulate use of a real ultrasound hardware machine. Thus, the ultrasound simulator 52 can be an effective training tool for users without requiring special hardware such as phantom models, imitation probes, or special controllers and users can train from any location as long as their device 64 can be connected to the server 58. The server 58 can be in communication with the client 54 and user interface 56 via the internet or intranet using standard protocols such as HTTP or HTTPS.

In one embodiment, the ultrasound simulator 52 can act as a classroom tool, where multiple users are connected to the same server 58 through multiple clients 54 for training. Users can be connected to the server 58 in a classroom or outside the classroom via the internet or intranet. A classroom can be any location for teaching purposes including hospitals, clinics, etc. In addition, specific user progress and user history can be recorded and stored on the server 58 for grading purposes or statistical purposes. Also, one of the clients 54 can act as a broadcast module for collaborative purposes such that the display on the user interface 56 of the broadcast module can be broadcasted to all other clients 54.

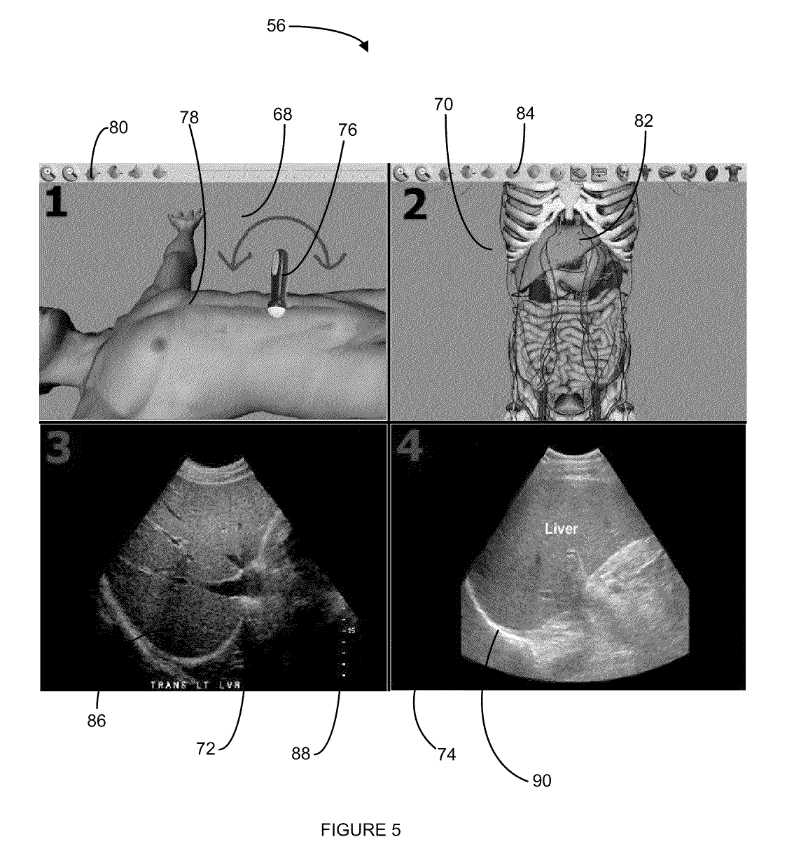

As shown in FIG. 5, the user interface 56 can be broken up into four viewing windows: a probe simulator window 68, an anatomical reference window 70, an ultrasound simulator window 72, and a final ultrasound window 74. The four windows can each have different features and functionalities, as described below.

The probe simulator window 68 can allow the user to virtually position an ultrasound probe 76 in relation to a three-dimensional (3-D) model 78 (e.g., of a body) in 3-D space. The model 78, which can consist of binary data, can be loaded into the probe simulator window 68 via the server 58.

In some embodiments, the model 78 can represent a 3-D object using a collection of points in 3-D space, connected by various geometric entities such as triangles, lines, curved surfaces, etc. The user can also choose the model 78 from a plurality of models, including male or female bodies in small, medium, and/or large body types, pregnant females, and infants. Each model 78 can include specific characteristics, such as different ranges flexibility among different body types. In addition, special training sessions can allow users to choose models 78 with specific pathologies, such as a model 78 with diseased tissue or tumors.

In the probe simulator window 68, the user can use the buttons 66 and controls 38 (such as ultrasound probe kinematics control, displayed in the user interface 56) to navigate the ultrasound probe 76 around the model 78 in a virtual setting. The user can move the ultrasound probe 76 around the model 78 as well as press the ultrasound probe 76 against the model 78 in a firmer or softer manner using the buttons 66 and controls 80. The ultrasound probe kinematics control can allow the ultrasound probe 76 to be manipulated within mechanical constraints similar to an ultrasound probe installed in an imaging center or hospital. For example, a real ultrasound probe may need to be positioned relative to an arm or leg of a human body at a specific angle to acquire the correct image. Thus, the simulator 10 can allow three-dimensional probe navigation, such that the user can specify a range of location and angle. The scale of probe rotation and position can be also be varied by the user (including a rotation increment and a position increment). In some embodiments, a grid in the probe simulator window 68 can be shown to aid the user in positioning the ultrasound probe 76 and/or the model 78.

In some embodiments, the controls 80 can include preset kinematics functions with accompanying slider functions, allowing preset procedures for ease of use. These preset kinematics functions can be based on known procedures and may be desirable for novice or beginner users.

In addition, the controls 80 can include a model kinematic function allowing the user to interact with the model 78. For example, the user can virtually flex or extend a knee or rotate the model 78 in the probe simulator window 68 using the controls 80. This can allow the user to practice positioning a patient, as well as the ultrasound probe, for an ultrasound. This can also allow the user to practice taking an ultrasound when a patient is lying in different positions. The user can also use the controls 80 to adjust their point of view (i.e., rotate around the model 78) in the probe simulator window 68 or to zoom in or out. Thus probe simulator window 68 can allow the user to obtain a three-dimensional virtual view of the model 34.

The anatomical reference window 70 can show an anatomical structure 82, which can be a virtual view of what is inside the body. The anatomical reference window 70 can allow the user to see underlining structures such as organs, bones, and muscles while the user navigates the ultrasound probe 76 on the model 78. For example, the probe simulator window 68 can show the model 78 with skin (as would be seen when positioning an ultrasound probe in real life), while the anatomical view window 28 can show the anatomical structure 82 with internal structures based off of the skinned model 78 in the probe simulator window 68.

In some embodiments, the user can view the anatomical structure 82 from any angle along with annotations identifying body parts. Using controls 84, the user can rotate, pan, or zoom views of the anatomical structure 82. In some embodiments, there can be a selectable range of navigation, allowing rotation only on limited axes or limited zoom functions. In addition, range can be limited to an area of the body. Some parts of the anatomical structure 82 can also be removed, or dissected (e.g., the user can toggle different body parts or different organ systems on or off). Also, a translucency function can be provided in the controls 84 to add the ability to see through body parts or organ systems in the anatomical structure 82. Further the anatomical reference window 70 can display the position of the ultrasound probe 76 as it is being navigated in the probe simulator window 68.

The anatomical reference window 70 can also function as a 3-D interface that leverages 3-D model data that is stored on the server 58. The user can have the ability to navigate views that may be difficult or not possible using predefined images, and therefore, each anatomical structure can be generated by the server 58. Because 3-D models are very complex and large, such models take significant time to be sent over the internet and generated by the client 54. Thus, the ability to render the anatomical structures 82 on the server 58 can allow similar functionality without the delay of load times. In some embodiments, the processor 62 can be used to generate the anatomical structures 82. The graphic capabilities of the server 58 can be changed or updated through the use of different graphics cards. After the server 58 renders the view of the anatomical structure 82, the resulting image is transmitted to the client 54 and displayed in the anatomical reference window 70. When the user uses the controls 84 to navigate the anatomical structure 82, the client 54 sends commands to the server 58 (such as rotate left, rotate right, zoom in, zoom out, pan, etc.). The commands are processed on the server 58 and an updated image of the anatomical structure 82 is then sent back to the client 54. The commands transmitted between the client 54 and the server 58 are synced, such that when the server 58 receives a command, the server 58 sends an acknowledgement to the client 54, notifying the client 54 that the server 58 has processed the command successfully.

In some embodiments, anatomical structures 82 can also be loaded and rendered within the client 54. Models 78 and anatomical structures 82 can be transferred from the server 58 as binary data and rendered using the client's computers graphic capabilities. This process can allow faster real-time feedback and allow off-line interaction to occur, so that the ultrasound simulator 52 can be used without a live internet or intranet connection.

The ultrasound simulator window 72 simulates an ultrasound image 86 based on the user's actions in the probe simulator window 68. Therefore, based on the position and rotation of the probe in the probe simulation window, the processor 62 can reconstruct the ultrasound image 86 and send it to the client 54. The ultrasound simulator window 72 can automatically update when the user interacts with the ultrasound probe 76 and controls 80. For example, when the ultrasound probe 76 in the probe simulator window 68 is manipulated, commands can be sent to the server 58 including data such as rotation, position and compression information. The server 58 then renders an ultrasound image 86 using the processor 62 and sends the ultrasound image 86 back to the client 54 in near real-time.

Depending on the controls 80 used, some updates can be generated through the client 54, rather than through the server 58. For example, when the user manipulates controls 80 such as brightness or contrast, updates to the ultrasound image 86 can be generated through the client 54. In some embodiments, the ultrasound simulator window 72 can also have controls 88 to simulate Doppler, invert image and angle correction functions. The controls 88 can act as an ultrasound control panel user interface, similar to that of a real ultrasound machine. In some embodiments, the user can have the ability to minimize and maximize the controls 88 in the ultrasound simulator window 72.

The ultrasound image 86 in the ultrasound simulator window 72 can be generated using real images acquired from an actual ultrasound hardware device (further described below). For example, the ultrasound probe 76 can equipped with a three-dimensional tracking device which tracks its position and orientation of the ultrasound probe 76. When the probe 34 is used to acquire data, the three-dimensional coordinates along with the base image generated from the ultrasound machine are processed together to constructed a three-dimensional volume. The processor 62 then interpolates any data that could not be processed. Interpolation can be used as the user navigates the ultrasound probe 76 in the probe simulator window 68 to simulate changing angles, compressions and Doppler functions.

The final ultrasound window 74 can be a static window showing the final image 90 that the user wants to achieve in the ultrasound simulator window 72. Achieving the final image 90 would be based on ultrasound probe position and compression in the probe simulator window 68 and the controls 88 in the ultrasound simulator window 72. Therefore, the user can be trained based upon a specified case, navigating the ultrasound probe 76 and use the controls 88 to match the final image 90.

The database 60 can store a plurality of final images 90, where each final image 90 can be for a specific training session. The final images 90 can be referenced by a grid. The images can be acquired and categorized based on studies. Different sets of images 48 can be displayed showing different pathologies, such as diseases. These images 48 are also referenced when generating the models 78, anatomical structures 82, and ultrasound images 44 in the probe simulator window 68, the anatomical window 28, and ultrasound simulator window 72, respectively. Images acquired using synthetic simulated tissue scanned using an ultrasound hardware device can also be stored in the database 60. Simulated tissue can give the advantage to train using pathologies such as tumors and diseases that can be constructed and acquired with detail.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and executed by a CPU. Such software could include, but is not limited to, firmware, resident software, microcode, and the like.

Furthermore, the invention can take the form of a computer program product accessible from a computer-usable or computer-readable medium providing program code for use by or in connection with a computer or any instruction execution system. For the purposes of this description, a computer usable or computer readable medium can be any apparatus for use by or in connection with the instruction execution system, apparatus, or device. The medium can store program code to execute one or more method steps set forth herein.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Network adapters may also be coupled to the system to enable the data processing system to become coupled to other data processing systems or remote printers or storage devices through intervening private or public networks. Modems, cable modem and Ethernet cards are just a few of the currently available types of network adapters.

In any case, it should be understood that the components illustrated herein may be implemented in various forms of hardware, software, or combinations thereof, for example, application specific integrated circuit(s) (ASICS), functional circuitry, one or more appropriately programmed general purpose digital computers with associated memory, and the like. Given the teachings of the invention provided herein, one of ordinary skill in the related art will be able to contemplate other implementations of the components of the invention.

It will be appreciated and should be understood that the exemplary embodiments of the invention described above can be implemented in a number of different fashions. Given the teachings of the invention provided herein, one of ordinary skill in the related art will be able to contemplate other implementations of the invention. Indeed, although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

1. A method of simulating an X-ray machine on a computer to train a user to operate the X-ray machine, the method comprising:
providing a server including a database and a processor;
providing the computer in communication with the server, the computer including a user interface and at least one of a mouse and a keyboard;
providing at least one simulator viewing window including a virtual body and a virtual X-ray tube and at least one simulated image viewing window including a simulated radiographic image on the user interface;
the user controlling a position of the virtual body and the virtual X-ray tube in the simulator viewing window using at least one of the mouse and the keyboard; and
the processor using the position of the virtual body and the virtual X-ray tube to generate the simulated radiographic image.

2. A method of simulating an ultrasound machine on a computer to train a user to operate the ultrasound machine, the method comprising:
providing a server including a database and a processor;
providing the computer in communication with the server, the computer including a user interface and at least one of a mouse and a keyboard,
providing at least one simulator viewing window including a virtual body and a virtual ultrasound probe and at least one simulated image viewing window including a simulated ultrasound image on the user interface;
the user controlling a position of the virtual body and the virtual ultrasound probe in the simulator viewing window using at least one of the mouse and the keyboard; and
the processor using the position of the virtual body and the virtual ultrasound probe to generate the simulated ultrasound image using an authentic ultrasound image stored in the database.
